(19) United States
(12) Patent Application Publication
(10) Pub. No.: US 2013/0206309 A1
(43) Pub. Date: Aug. 15, 2013

(54) PASSENGER VEHICLE TIRE HAVING A RADIAL CARCASS REINFORCEMENT

(71) Applicant: Michel Deal, Clermont-Ferrand Cedex 9 (FR)

(72) Inventor: Michel Deal, Clermont-Ferrand Cedex 9 (FR)

(73) Assignee: Compagnie Generale des EEstablissements Michelin, Clermont-Ferrand (FR)

(21) Appl. No.: 13/878,925

(22) PCT Filed: Oct. 12, 2011
(86) PCT No.: PCT/EP11/67796

§ 371 Date: Apr. 26, 2013

(30) Foreign Application Priority Data
Oct. 13, 2010 (FR) 1058340

(51) Int. Cl. B60C 9/18

(52) U.S. Cl. CPC B60C 9/18
USPC 152/534

(57) ABSTRACT

The invention relates in particular to a passenger vehicle tire, the crown reinforcement of which consists of:
a radial carcass reinforcement,
a working reinforcement consisting of a single layer of reinforcers inclined by an angle “α” with respect to the circumferential direction (DC) of the tire, the angle α being between 4 and 7 degrees,
a flat circumferential polymer reinforcer positioned in a central portion of the crown.

### BACKGROUND

1. Field

The present invention relates to tires, and more particularly to passenger vehicle tires with a radial carcass.

2. Description of Related Art

Tires with a radial carcass, commonly referred to as “radial tires”, have gradually become the norm in most markets, particularly in the passenger vehicle (passenger car) tire market. This success is due in particular to the qualities of durability, comfort, lightness and low rolling resistance that radial tire technology enjoys.

The radial tire is essentially made up of flexible sidewalls and of a more rigid crown, the sidewalls extending radially from the beads as far as the shoulders, the shoulders between them delimiting the crown, the crown supporting the tire tread. Because each of these parts of the tire has its own specific functions, it also has its own special reinforcement. One feature of radial tire technology is that the reinforcement of each of these parts can be precisely adapted relatively independently of each other.

The crown reinforcement of a passenger vehicle radial tire (commonly referred to as a “passenger tire”) comprises, in a known manner, the following elements:
a radial carcass reinforcement formed of reinforcers (generally textile) connecting the two beads of the tire,
two crossed crown triangulation layers (or plies) essentially consisting of reinforcers (generally metal cords) each forming an angle of about 30° with the circumferential direction of the tire,
a crown belt essentially consisting of reinforcers practically parallel to the circumferential direction of the tire, often referred to as “0° reinforcers” even though in general they make a non-zero angle with the circumferential direction, due to the winding of said reinforcers.

In broad terms, the carcass can be said to have the prime function of containing the internal pressure of the tire, that the crossed plies have the prime function of interacting with the carcass to give the tire its cornering stiffness and that the crown belt has the prime function of resisting centrifugal effects on the crown, in particular on its central portion, at high speed. It can also be said that it is the interaction between all these reinforcement elements that gives the tire its ability to retain a relatively cylindrical shape in the face of the various stress loadings.

Each of these elements of the crown reinforcement is generally combined by calendering with rubber compounds. The stack of these elements is then joined together during the vulcanising of the tire.

After several decades of research, progress and development of radial tire architecture, it is the combination of all these reinforcement elements (carcass, crossed layers, belt) that allows the radial tire to achieve the undeniable comfort, service life and cost performance that has made it the success it is. Throughout this development, attempts have been made to improve the performance of the tires, for example in terms of their mass and their rolling resistance. Thus the crown of radial tires has gradually reduced in thickness as increasingly high-performance reinforcers have been adopted and increasingly thinner layers of calendering rubber have been used so that tires that are as light as possible can be manufactured.

### SUMMARY

It is one objective of the invention to allow a significant further reduction in the mass of the crown and therefore of the tires for passenger vehicles, without reducing their performance in terms of safety and service life.

This objective is achieved by the invention which proposes a passenger vehicle tire, the crown reinforcement of which consists of:
a radial carcass reinforcement,
a working reinforcement consisting of a single layer of reinforcers inclined by an angle α with respect to the circumferential direction DC of the tire, the angle α being between 4 and 7 degrees,
a flat circumferential polymer reinforcer positioned in a central portion of the crown.

Preferably, the angle α is between 5 and 6 degrees.

According to a first variant of the invention, the reinforcers of the working layer are preferably steel cords.

According to a second variant of the invention, the reinforcers of the working layer are preferably aramid cords.

According to a third variant of the invention, the reinforcers of the working layer are preferably steel bands.

Preferably, the flat circumferential reinforcer is made of a thermoplastic polymer film.

More preferably, the thermoplastic polymer film is a multiaxially drawn polyethylene terephthalate (PET) film.

Preferably, the flat circumferential reinforcer is situated radially on the outside of the working reinforcement.

Preferably, the flat circumferential reinforcer has a thickness between 0.25 and 0.50 mm.

Preferably, the width of the flat circumferential reinforcer is at least equal to half the width of the tire.

### BRIEF DESCRIPTION OF DRAWINGS

The invention will be better understood from the remainder of the description which is based on the following figures:

FIG. 1 is a cutaway view schematically showing the architecture of a tire according to the prior art,

FIG. 2 is a cutaway view showing the architecture of a tire according to a first embodiment of the invention,

FIG. 3 is a cutaway view showing the architecture of a tire according to a second embodiment of the invention,

FIG. 4 is a perspective view of the working reinforcement according to a third embodiment of the invention,

FIGS. 5 and 6 are top views of the working layer and of how it is obtained starting from a semi-finished product.

### DETAILED DESCRIPTION OF SPECIFIC EMBODIMENTS

In the various figures, identical or similar elements bear the same reference number. The description thereof is not therefore systematically repeated.

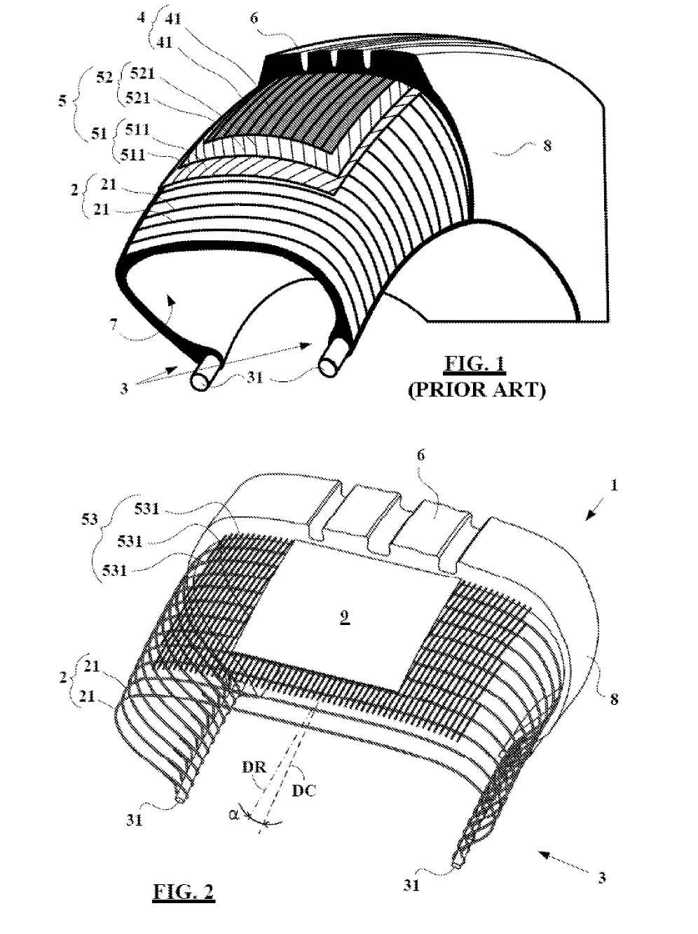

FIG. 1 schematically represents, in a cutaway view, a passenger vehicle radial tire according to the prior art. Its carcass reinforcement 2 which connects the two beads 3 formed around bead wires 31 may be seen. The carcass reinforcement is formed of radially oriented reinforcers 21. The reinforcers 21 are textile cords (for example made of nylon, rayon or polyester). The carcass constitutes the sole reinforcement of the sidewalls 8.

In the crown, that is to say between the two shoulders of the tire, the carcass is surmounted by two crossed triangulation layers 51 and 52 and by a belt 4.

The two crossed crown triangulation layers 51 and 52 comprise reinforcers (511 and 521 respectively) oriented at an angle generally of between 20° and 40° on each side of the circumferential direction of the tire. The reinforcers of the crossed layers are essentially metal cords. These crossed plies are commonly denoted under the name of “working plies” and together they form what is referred to as the “working reinforcement” 5.

The crown belt 4 essentially consists of reinforcers 41 oriented parallel to the circumferential direction of the tire (often referred to as “0° reinforcers”). These reinforcers are generally textile cords (for example made of nylon, rayon, polyester, aramid) or hybrid cords (for example aramid-nylon cords). In practice, due to their helical winding, the reinforcers of the crown belt are not strictly parallel to the circumferential direction, but form an angle with this direction. This angle, which is extremely small, is considered to be negligible. It is generally of the order of a tenth of a degree, for example between 0.05 and 0.5 degree depending on the diameter of the reinforcer cord or on the width of the corded strip of reinforcer that is used.

An inner liner layer 7 covers the cavity of the tire. A tread 6 caps the crown reinforcement.

FIG. 2 represents a first embodiment of a tire according to the invention. In the cutaway portion of this view, the reinforcers are represented bare, i.e. without the various layers of rubber. An essential feature of the invention is that the crown reinforcement comprises a single working reinforcement layer 53. A second essential feature is that the angle of inclination of the reinforcers 531 of the working reinforcement, i.e. the angle “α” between the direction of the reinforcers DR and the circumferential direction DC, is between 4 and 7 degrees. The angle α is equal to 7 degrees in this example. A third essential feature of the invention is the presence of a flat circumferential polymer reinforcer 9 positioned in the central portion of the crown.

In this example, the reinforcers 531 of the working reinforcement are metal cords of the type of those used for the crossed plies according to the prior art, for example for a passenger tire of dimension 205/55 R16, “2×30” steel cords referred to thus because they consist of two twisted steel wires, each wire having a diameter of 0.3 mm. Aramid cords may also be used instead of steel cords.

The tire according to the invention therefore comprises a single working layer 53 and is additionally lacking a crown belt, this role being fulfilled by the working layer.

The radial carcass 2 and the beads 3 may be identical or similar to what was described regarding the prior art in support of FIG. 1.

Surprisingly, the functional features of this tire are quite comparable to those of a tire according to the prior art. On the other hand, its weight is substantially lower. This is of course due to the absence of two of the three layers of reinforcers according to the prior art, and also to the reduction in the total thickness of the crown of the tire.

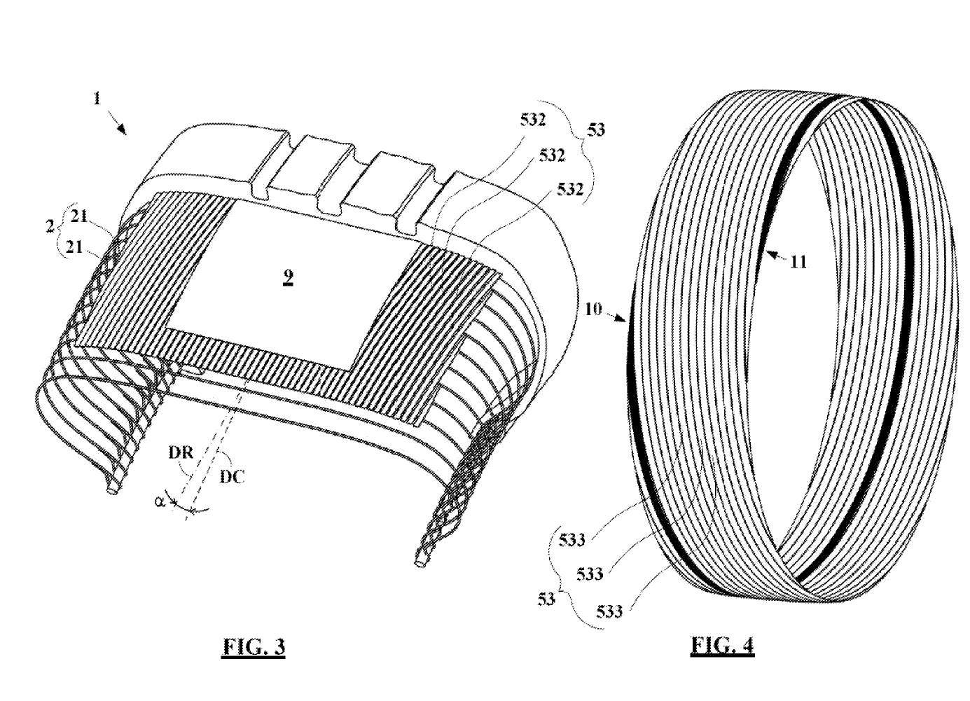

FIG. 3 represents, in a manner similar to FIG. 2, a second embodiment of the invention. This embodiment essentially differs from the first embodiment in that the working reinforcers are flat steel bands 532 and not cords. The width of a steel band is here around 3 mm. The angle α that these reinforcers make with the circumferential direction DC is here equal to around 7 degrees, as in the first embodiment. Steel bands that are from 0.3 to 0.4 mm thick seem, for example, to be suitable for a tire of dimension 205/55 R16. The use of flat reinforcers instead of cords makes it possible to increase the reinforcer density of the working layer. It is therefore possible to further reduce the thickness of the working layer and of the whole of the crown. Therefore, the mass of the tire can thus be further reduced. Moreover, the bond with the flat polymer reinforcer 9 is better, which favours the cornering stiffness of the tire.

FIG. 4 represents the working reinforcement 53 of a third embodiment of the tire according to the invention. The reinforcers are here formed by reinforced rubber strips 533 having a width of around 10 mm. 16 strips are positioned side by side in order to form a working reinforcement having a width of around 160 mm that is suitable for a passenger tire of dimension 205/55 R16. The angle α is here equal to 5.5 degrees. Each strip may comprise a certain number of steel cords, for example 2×30 cords as described above at a pitch of 0.8 mm or 167/2 TEX aramid cords having a diameter of 0.7 mm at a pitch of 0.9 mm.

In the representation of FIG. 4, one of the strips has been darkened to enable the reader to follow it over its entire length. It is thus seen that between the start 10 of a strip 533 on one of the shoulders and the end 11 of the same strip on the other shoulder, each strip travels a length of around one circumference of the tire. This length of around one circumference constitutes a preferred feature of the invention. It is clearly understood that depending on the diameter of the tire, depending on the width of the stripe, depending on the width of the working reinforcement 53 and of course depending on the angle α specifically chosen, the length of the strips and therefore of the reinforcers of the working layer varies around this value of one tire circumference. However, in general according to the invention, this length preferably remains between 0.5 and 2 circumferences. What this representation illustrates as regards the arrangement and the length of the reinforcers in the working reinforcement is not limited to working reinforcers of one particular type but is on the contrary valid for all types of working reinforcers. The same figure could also illustrate the use, as reinforcer, of a 10 mm wide steel band.

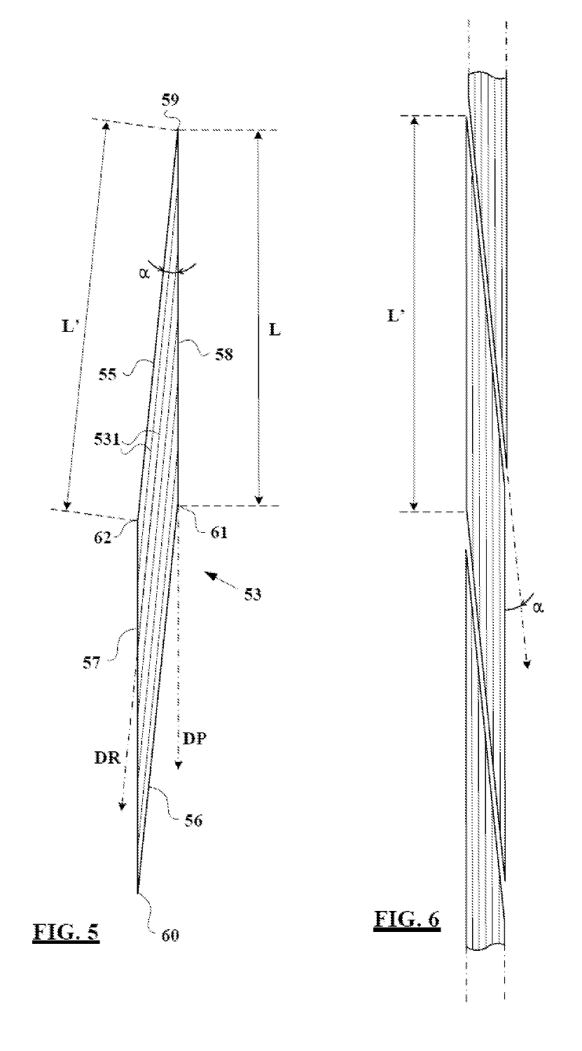

FIG. 5 schematically illustrates an example of a semi-finished product prepared in order to form a working reinforcement 53 according to the invention. Here it is a ply, the reinforcers 531 of which are inclined by 5.5 degrees with respect to the direction of fitting on the carcass (DP), i.e. with respect to the circumferential direction DC of the tire. This semi-finished product has the shape of a lozenge. The edges 55 and 56 are intended to come against one another when being fitted, i.e. the upper point 59 is positioned close to the right corner 61 whereas the lower point 60 is positioned close to the left corner 62. The length L of the edges 57 and 58 corresponds to the circumference of the working reinforcement once fitted. In order to better represent the positioning of the working layer, reference may be made to FIG. 4 and it may be imagined that one of the edges of the darkened strip corresponds, for example, to the join of the edges 55 and 56 of the semi-finished product after it is fitted on the carcass.

The FIG. 6 illustrates a way of preparing the working layer according to the invention starting from a very long semi-finished product ply. The semi-finished product is cut at the angle α so as to form the lozenge of FIG. 5. The length L′ between two cuts corresponds to the edges 55 and 56 of the lozenge. Due to the angle of 5.5 degrees in this example, the cut length L′ is barely longer than the length L described above. For a same length and a same width of the working layer, it is understood that a cutting angle α closer to 7 degrees would give rise to a shorter cut length L′, whereas a cutting angle α closer to 4 degrees would correspond to a longer cut length L′.

As described further with reference to FIGS. 2 and 3, an essential feature of the invention is the presence of a flat circumferential polymer reinforcer 9 positioned in the central portion of the crown. The sizing of this reinforcer makes it possible to precisely adjust the cornering stiffness of the tire independently of the other features. A person skilled in the art knows how to decide on this sizing as a function of the stiffness values desired for a given tire, for example by carrying out successive tests. The width of the central circumferential reinforcer 9 is preferably at least equal to half the width of the tire. The expression “width of the tire” is understood to mean its normalized width, i.e. for example 205 mm for a tire of dimension 205/55 R16.

The central circumferential reinforcer 9 may be placed between the carcass reinforcement 2 and the working reinforcement 5 or placed radially on the outside of these two reinforcements, as represented in FIGS. 2 and 3. One advantage of the arrangement represented is that it also provides protection for the crown against attack (puncturing, cuts).

The central circumferential reinforcer 9 may be continuous, i.e. run the entire circumference of the tire without interruption. It may then be abutted with an overlap or on the contrary have free ends, preferably edge to edge and cut at around 45 degrees. The central circumferential reinforcer 9 may also be discontinuous, i.e. consist of several parts successively positioned along the circumference of the tire, preferably edge to edge and cut at 45 degrees.

The central circumferential reinforcer 9 is preferably made of thermoplastic polymer. For example, a thermoplastic polymer film that is multiaxially drawn, i.e. drawn or oriented in more than one direction, can be used. Such multiaxially drawn films are well known, used mainly to date in the packaging industry, in the food industry, in the electrical field or else as a support for magnetic coatings.

They are prepared according to various well-known drawing techniques, all intended to give the film high mechanical properties in several main directions and not in a single direction as is the case for standard thermoplastic polymer fibres (for example PET or nylon fibres) which are, in a known manner, uniaxially drawn during the melt spinning thereof.

Such techniques require multiple drawing operations in several directions, longitudinal drawing, transverse drawing and planar drawing operations. By way of example, mention may especially be made of the biaxial stretch-blow moulding technique.

Multiaxially drawn thermoplastic polymer films and also the methods for obtaining them have been described in numerous patent documents, for example in documents FR 2539349 (or GB 2134442), DE 3621205, EP 229346 (or U.S. Pat. No. 4,876,137), EP 279611 (or U.S. Pat. No. 4,867,937), EP 539302 (or U.S. Pat. No. 5,409,657) and WO 2005/011978 (or US 2007/0031691).

The drawing operations may be carried out in one or more stages; when there are several drawing operations these may be simultaneous or sequential. The draw ratio or ratios applied are a function of the targeted final mechanical properties, generally greater than 2.

Preferably, the thermoplastic polymer film used has, irrespective of the tensile direction considered, a tensile modulus, denoted by E, which is greater than 500 MPa (especially between 500 and 4000 MPa), more preferably greater than 1000 MPa (especially between 1000 and 4000 MPa), more preferably still greater than 2000 MPa. Values of the modulus E between 2000 and 4000 MPa, in particular between 3000 and 4000 MPa are particularly desirable as the crown triangulation layer according to the invention.

According to another preferred embodiment, irrespective of the tensile direction considered, the maximum tensile stress, denoted by σₘₐₓ, of the thermoplastic polymer film is preferably greater than 80 MPa (especially between 800 and 200 MPa), more preferably greater than 100 MPa (especially between 100 and 200 MPa). Values of the stress σₘₐₓ greater than 150 MPa, in particular between 150 and 200 MPa, are particularly desirable.

According to another preferred embodiment, irrespective of the tensile direction considered, the yield point, denoted by Yp, of the thermoplastic polymer film is located above 3% elongation, especially between 3% and 15%. Values of Yp above 4%, in particular between 4% and 12%, are particularly desirable.

According to another preferred embodiment, irrespective of the tensile direction considered, the thermoplastic polymer film has an elongation at break, denoted by Ar, which is greater than 40% (especially between 40% and 200%), more preferably greater than 50%. Values of Ar between 50% and 200% are particularly desirable.

The abovementioned mechanical properties are well known to a person skilled in the art, deduced from force-elongation curves, measured for example according to the standard ASTM F638-02 for strips having a thickness greater than 1 mm, or else according to the standard ASTM D882-09 for thin sheets or films, the thickness of which is at most equal to 1 mm; the above modulus E and stress σₘₐₓ values, expressed in MPa, are calculated with respect to the initial cross section of the test specimen subjected to the tensile test.

The thermoplastic polymer film used is preferably of the thermally stabilized type, i.e. it has undergone, after drawing, one or more heat treatments intended, in a known manner, to limit the thermal contraction (or shrinkage) thereof at high temperature; such heat treatments may especially consist of post-curing or hardening treatments, or combinations of such post-curing or hardening treatments.

Thus, and preferably, the thermoplastic polymer film used has, after 30 min at 150° C., a contraction relative to its length which is less than 5%, preferably less than 3% (measured according to ASTM D1204).

The melting point (“Tₘ”) of the thermoplastic polymer used is preferably chosen to be above 100° C., more preferably above 150° C., in particular above 200° C.

The thermoplastic polymer is preferably selected from the group consisting of polyamides, polyesters and polyimides, more particularly from the group consisting of polyamides and polyesters. Among the polyamides, mention may especially be made of the polyamides PA-4,6, PA-6, PA-6,6, PA-11 or PA-12. Among the polyesters, mention may be made, for example, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate).

The thermoplastic polymer is preferably a polyester, more preferably a PET or PEN.

Examples of multiaxially drawn PET thermoplastic polymer films, suitable for the crown triangulation layer of the invention, are for example the biaxially drawn PET films sold under the names “Mylar” and “Melinex” (DuPont Teijin Films), or else “Hostaphan” (Mitsubishi Polyester Film).

In the circumferential reinforcer 9, the thickness of the thermoplastic polymer film is preferably between 0.05 and 1 mm, more preferably between 0.1 and 0.7 mm. For example, film thicknesses of 0.25 to 0.50 mm have proved to be perfectly suitable.

The thermoplastic polymer film may comprise additives added to the polymer, especially at the moment when the latter is formed, these additives possibly being, for example, agents for protecting against ageing, plasticizers, fillers such as silica, clays, talc, kaolin or else short fibres; fillers may for example make the surface of the film rough and thus contribute to improving the adhesive uptake thereof and/or the adhesion thereof to the rubber layers with which said film is intended to be in contact.

According to one preferred embodiment of the invention, the thermoplastic polymer film is provided with an adhesive layer facing each layer of rubber composition with which it is in contact.

In order to adhere the rubber to the thermoplastic polymer film, use could be made of any appropriate adhesive system, for example a simple textile adhesive of the “RFL” (resorcinol-formaldehyde-latex) type comprising at least one diene elastomer such as natural rubber, or any equivalent adhesive known for imparting satisfactory adhesion between rubber and conventional thermoplastic fibres such as polyester or polyamide fibres.

By way of example, the adhesive coating process may essentially comprise the following successive steps: passage through a bath of adhesive, followed by drainage (for example by blowing, grading) to remove the excess adhesive; then drying, for example by passing into an oven (for example for 30 s at 180° C.) and finally heat treatment (for example for 30 s at 230° C.).

Before the above adhesive coating, it may be advantageous to activate the surface of the film, for example mechanically and/or physically and/or chemically, to improve the adhesive uptake thereof and/or the final adhesion thereof to the rubber. A mechanical treatment could consist, for example, of a prior step of matting or scratching the surface; a physical treatment could consist, for example, of a treatment via radiation such as an electron beam; a chemical treatment could consist, for example, of prior passage into a bath of epoxy resin and/or isocyanate compound.

Since the surface of the thermoplastic polymer film is, as a general rule, particularly smooth, it may also be advantageous to add a thickener to the adhesive used, in order to improve the total adhesive uptake of the film during the adhesive coating thereof.

A person skilled in the art will readily understand that the connection between the thermoplastic polymer film and each layer of rubber with which it is in contact is definitively provided during the final curing (crosslinking) of the tire.

Tires according to the embodiment of FIG. 2 were compared to passenger tires according to the prior art.

The dimension tested is 205/55 R16. The tire according to the prior art (MICHELIN ENERGY™ Saver 205/55 R16) has a mass of 8 kg. The tire according to the invention has a mass of 7.1 kg when the reinforcers of the working layer are steel cords and a mass of 6.8 kg when the reinforcers of the working layer are aramid cords. The saving in mass is therefore 11% and 15% respectively.

1. Passenger vehicle tire, comprising a crown, the crown comprising a crown reinforcement of which consists of:
a radial carcass reinforcement,
a working reinforcement consisting of a single layer of reinforcers inclined by an angle “α” with respect to the circumferential direction (DC) of the tire, the angle α being between 4 and 7 degrees,
a flat circumferential polymer reinforcer positioned in a central portion of the crown.

2. Tire according to claim 1, in which the angle α is between 5 and 6 degrees.

3. Tire according to claim 1, in which the reinforcers of the working layer are steel cords.

4. Tire according to claim 1, in which the reinforcers of the working layer are aramid cords.

5. Tire according to claim 1, in which the reinforcers of the working layer are steel bands.

6. Tire according to claim 1, in which the flat circumferential reinforcer is made of a thermoplastic polymer film.

7. Tire according to claim 6, in which the thermoplastic polymer film is a multiaxially drawn polyethylene terephthalate (PET) film.

8. Tire according to claim 1, in which the flat circumferential reinforcer is situated radially on the outside of the working reinforcement.

9. Tire according to claim 1, in which the flat circumferential reinforcer has a thickness between 0.25 and 0.50 mm.

10. Tire according to claim 1, in which the width of the flat circumferential reinforcer is at least equal to half the width of the tyre.

11. Tire according to claim 1, wherein the flat circumferential polymer reinforce comprises a thermoplastic polymer film having at least one adhesive layer thereon.

12. Tire according to claim 1, further comporising one or more layers of calendaring rubber in the crown.
